(19) United States
(12) Patent Application Publication
(10) Pub. No.: US 2026/0237990 A1
(43) Pub. Date: Aug. 13, 2026

(54) WIRE FIXING MEMBER AND WIRE HARNESS

(71) Applicant: SUMITOMO WIRING SYSTEMS, LTD., Yokkaichi-shi, Mie (JP)

(72) Inventor: Naoto TSUKIMORI, Yokkaichi-shi (JP)

(73) Assignee: SUMITOMO WIRING SYSTEMS, LTD., Yokkaichi-shi, Mie (JP)

(21) Appl. No.: 19/156,180

(22) PCT Filed: Feb. 6, 2024
(86) PCT No.: PCT/JP2024/003846

§ 371 Date: Aug. 13, 2025

(30) Foreign Application Priority Data
Feb. 22, 2023 (JP) 2023-026014

(51) Int. Cl. H02G 3/32; B60R 16/02

(52) U.S. Cl. CPC H02G 3/32; B60R 16/0215

(57) ABSTRACT

A wire fixing member that is configured to fix a wire to a fixed portion, the wire fixing member including: a fixing member body configured to hold the wire and having a placement surface on which the fixed portion is to be disposed; and a clamp that is separate from the fixing member body and is to be attached to the fixing member body, wherein the placement surface and the clamp are configured to clamp the fixed portion therebetween.

### BACKGROUND

The present disclosure relates to a wire fixing member and a wire harness.

JP 2012-110133A discloses a wire fixing member configured to be fixed to a plate-like bracket provided in a vehicle, for example. The wire fixing member includes a holding portion that holds a wire member and a fixing portion configured to be fixed to the plate-like bracket. The fixing portion has an insertion hole into which the bracket is inserted. A locking portion that engages with the bracket is provided inside the insertion hole so as to prevent the bracket from coming out of the insertion hole.

### SUMMARY

The thicknesses of brackets in a vehicle are set to various thicknesses depending on the weight and the like of the wire members, from the viewpoint of securing strength. With the wire fixing member described above, it is necessary to design the size of the insertion hole and the like in accordance with the thickness of the bracket. For example, consider the case where a wire fixing member suitable for a first bracket is fixed to a second bracket that is thinner than the first bracket. In this case, a large gap formed between the insertion hole of the wire fixing member and the second bracket may cause rattling or even dropout of the wire fixing member. Therefore, it is necessary to prepare various types of wire fixing members according to the thickness of the bracket.

An exemplary aspect of the disclosure provides a wire fixing member and a wire harness that enable an improvement in versatility.

A wire fixing member according to the present disclosure is a wire fixing member for fixing a wire member to a plate-like fixed portion, the wire fixing member including: a fixing member body having a holding portion configured to hold the wire member and a placement surface on which the fixed portion is to be disposed; and a clamping member that is separate from the fixing member body and is to be attached to the fixing member body, wherein the placement surface and the clamping member are configured to clamp the fixed portion therebetween.

With the wire fixing member and the wire harness according to the present disclosure, it is possible to improve the versatility.

### BRIEF DESCRIPTION OF THE DRAWINGS

FIG. 1 is a front view of a wire harness according to an embodiment.

FIG. 2 is a plan view of the wire harness according to the embodiment.

FIG. 3 is a cross-sectional view taken along line 3-3 in FIG. 2.

FIG. 4 is a cross-sectional view showing a portion of a wire fixing member according to a variation.

### DETAILED DESCRIPTION OF EMBODIMENTS

### Description of Embodiments of Present Disclosure

First, embodiments of the present disclosure will be listed and described.

A wire fixing member according to the present disclosure is
[1] a wire fixing member for fixing a wire member to a plate-like fixed portion, the wire fixing member including: a fixing member body having a holding portion configured to hold the wire member and a placement surface on which the fixed portion is to be disposed; and a clamping member that is separate from the fixing member body and is to be attached to the fixing member body, wherein the placement surface and the clamping member are configured to clamp the fixed portion therebetween.

According to this configuration, by changing the distance between the placement surface of the fixing member body and the clamping member, it is possible to clamp various types of fixed portions having different thicknesses while suppressing rattling. In other words, by changing the distance between the placement surface and the clamping member in accordance with the thickness of the fixed portion, it is possible to accommodate various types of fixed portions having different thicknesses. Accordingly, the versatility of the wire fixing member can be improved.
[2] In the wire fixing member according to [1] above, a configuration is also possible in which the fixing member body includes a first locking portion, the clamping member includes a second locking portion configured to engage with the first locking portion, the fixing member body and the clamping member are fixed to each other by engagement of the first locking portion and the second locking portion, and the first locking portion and the second locking portion are configured to fix the clamping member at a plurality of fixing positions having different distances from the placement surface.

According to this configuration, the distance between the placement surface of the fixing member body and the clamping member can be changed by the configuration of the first locking portion and the second locking portion.
[3] In the wire fixing member according to [2] above, a plurality of combinations of the first locking portion and the second locking portion engaging with the first locking portion may be provided.

According to this configuration, by providing a plurality of combinations of the first locking portion and the second locking portion, it is possible to firmly fix the clamping member to the fixing member body.
[4] In any one of the wire fixing member according to [1] to [3] above, one of the placement surface and the clamping member may include a protruding portion that is to be inserted into a hole provided in the fixed portion.

According to this configuration, the protruding portion inserted into the hole of the fixed portion can prevent the fixed portion from coming out of the space between the placement surface and the clamping member.
[5] A wire harness according to the present disclosure includes the wire fixing member according to any one of [1] to [4] above, and a wire member held by the wire fixing member.

According to this configuration, it is possible to achieve operations and effects similar to those of the above wire fixing member.

### Details of Embodiments of Present Disclosure

Specific examples of a wire fixing member and a wire harness according to the present disclosure will be described below with reference to the drawings. In the drawings, the configurations may be partially exaggerated or simplified for convenience in the description. Also, the dimensional ratios of various portions may differ among the drawings. The terms “parallel” and “orthogonal” in this specification include not only strictly parallel and orthogonal relationships, but also approximately parallel and orthogonal relationships to the extent that effects of the present embodiment are exhibited.

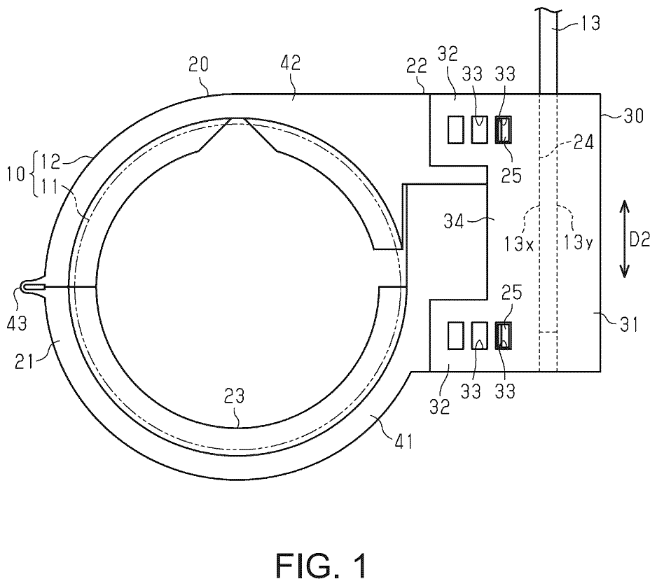

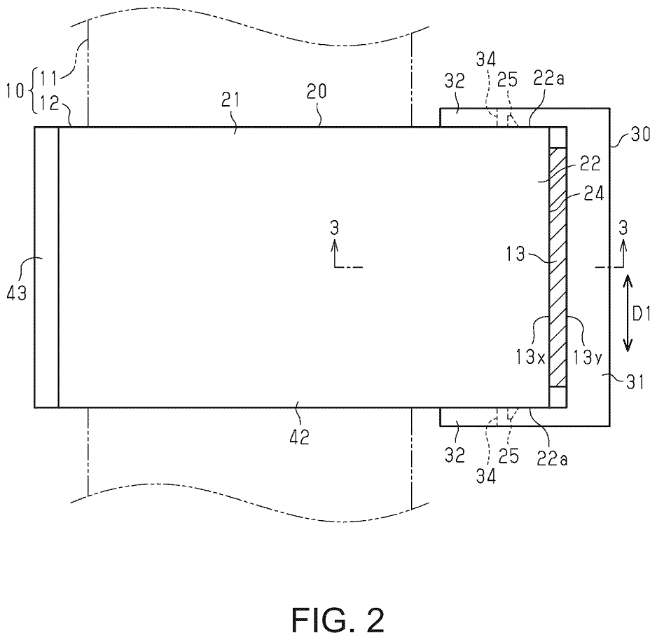

As shown in FIGS. 1 and 2, a wire harness 10 according to the present embodiment is provided in a vehicle such as an automobile, for example. The wire harness 10 includes a wire member 11 (wire) and a wire fixing member 12. The wire fixing member 12 is a component for fixing to a plate-like fixed portion 13 provided in the vehicle. The fixed portion 13 is, for example, a metal plate-like bracket. The wire member 11 electrically connects two or more in-vehicle devices to each other. The wire member 11 includes, for example, a wire and an exterior member that covers the wire.

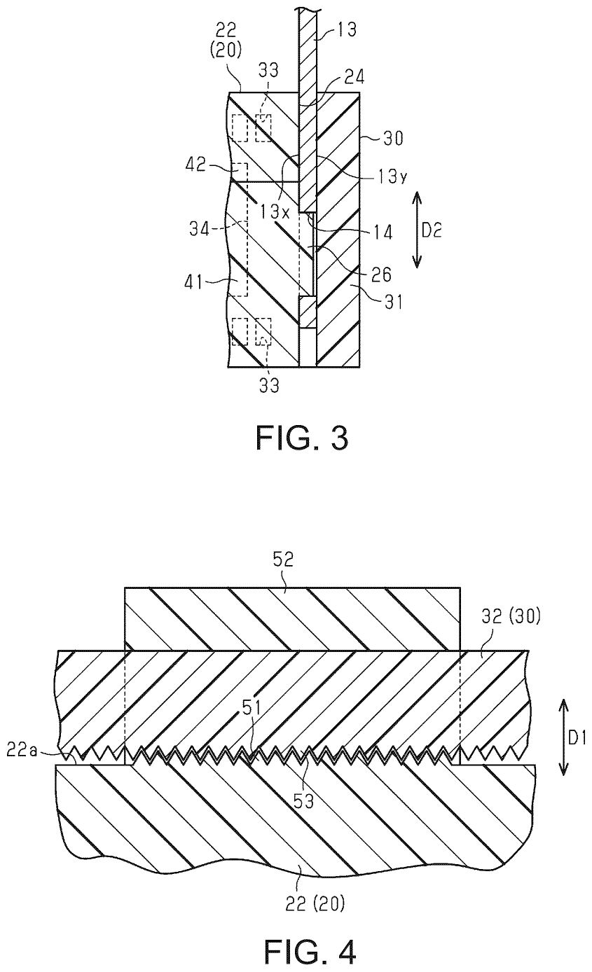

The plate-like fixed portion 13 has a first main surface 13x and a second main surface 13y that are parallel to each other. As shown in FIG. 3, the fixed portion 13 has, for example, a hole 14. The hole 14 is, for example, a through hole extending through the fixed portion 13 from the first main surface 13x to the second main surface 13y.

### Wire Fixing Member 12

As shown in FIGS. 1 and 2, the wire fixing member 12 includes a fixing member body 20, and a clamping member 30 (clamp) that is separate from the fixing member body 20. The fixing member body 20 and the clamping member 30 are made of synthetic resin, for example. The fixing member body 20 and the clamping member 30 clamp the fixed portion 13 in the thickness direction.

The fixing member body 20 has a holding portion 21 that holds the wire member 11 and an attachment portion 22 to which the clamping member 30 is attached.

As shown in FIG. 1, the holding portion 21 has an annular shape as viewed in the length direction of the wire member 11. The holding portion 21 surrounds the wire member 11. In this manner, the wire member 11 is held by the holding portion 21. The holding portion 21 includes, for example, a protruding portion 23 (protrusion) protruding from an inner circumferential surface of the holding portion 21. The protruding portion 23 is configured to restrict the wire member 11 from moving in the length direction. Relative positional shifting of the wire member 11 and the wire fixing member 12 in the length direction is suppressed by the protruding portion 23 restricting the wire member 11 from moving in the length direction. When the above-described exterior member of the wire member 11 is, for example, a corrugated tube, the protruding portion 23 fits into a recessed portion of the outer circumferential surface of the corrugated tube.

### Attachment Portion 22

As shown in FIGS. 1 and 2, the attachment portion 22 has a placement surface 24 on which the fixed portion 13 is disposed, and a plurality of first locking portions 25 (first locks). The placement surface 24 is, for example, planar and parallel to the fixed portion 13.

As shown in FIG. 3, the placement surface 24 includes a protruding portion 26 (protrusion) that is to be inserted into the hole 14 of the fixed portion 13, for example. By the protruding portion 26 entering the hole 14, the fixed portion 13 is positioned in the direction parallel to the placement surface 24. For example, the fixed portion 13 is positioned in a width direction D1 and a height direction D2 by the protruding portion 26.

As shown in FIG. 2, the plurality of first locking portions 25 are, for example, locking protruding portions that protrude from opposite side surfaces 22a in the width direction D1 of the attachment portion 22. Aplurality of pairs of first locking portions 25 respectively provided on the two side surfaces 22a of the attachment portion 22 are arranged in the height direction D2 of the attachment portion 22 (see FIG. 1). The pair of first locking portions 25 are respectively provided near one end portion and the other end portion of the attachment portion 22 in the height direction D2. In other words, the attachment portion 22 of the present embodiment is provided with four first locking portions 25. Fixing pieces 32 (described later) of the clamping member 30 respectively engage with the first locking portions 25. Note that the height direction D2 of the attachment portion 22 is a direction parallel to the placement surface 24 and perpendicular to the width direction D1. The fixed portion 13 is disposed along the height direction D2 so as to be in contact with the placement surface 24.

As shown in FIG. 1, the fixing member body 20 is, for example, divided into two parts, namely, a first part 41 and a second part 42, from the holding portion 21 to the attachment portion 22. The first and second parts 41 and 42 are connected to each other via a hinge portion 43. The first part 41, the second part 42, and the hinge portion 43 are formed as one piece. The second part 42 can be rotated about the hinge portion 43 relative to the first part 41. The hinge portion 43 is provided, for example, on the holding portion 21.

The attachment portion 22 of the fixing member body 20 is constituted by, for example, a portion of the first part 41 and a portion of the second part 42. In the attachment portion 22, a state in which the first part 41 and the second part 42 are closed is maintained by coupling of coupling portions (not shown) respectively provided in the first part 41 and the second part 42. The placement surface 24 of the attachment portion 22 is constituted by, for example, a portion of the first part 41 and a portion of the second part 42. The first locking portions 25 are respectively provided, for example, on the first part 41 and the second part 42 of the attachment portion 22.

### Clamping Member 30

As shown in FIGS. 1 and 2, the clamping member 30 has, for example, a body portion 31 and a plurality of fixing pieces 32 extending from the body portion 31. The fixing pieces 32 extend from the body portion 31 in a direction perpendicular to the placement surface 24. The fixing pieces 32 each have second locking portions 33 (second locks) that engage with the first locking portions 25 of attachment portion 22. The second locking portions 33 in each fixing piece 32 is, for example, through holes extending through the fixing piece 32 in the width direction D1. Then, each first locking portion 25 enters and is engaged with the corresponding second locking portion 33 of the fixing piece 32, so that the clamping member 30 is fixed to the attachment portion 22 with the fixed portion 13 clamped between the placement surface 24 and the body portion 31 in the thickness direction. In a state where the fixed portion 13 is clamped between the placement surface 24 and the body portion 31, the placement surface 24 is in contact with the first main surface 13x of the fixed portion 13, and the body portion 31 is in contact with the second main surface 13y of the fixed portion 13.

The first locking portions 25 of the attachment portion 22 and the second locking portions 33 of the clamping member 30 are configured to fix the clamping member 30 at a plurality of fixing positions having different distances from the placement surface 24.

Specifically, in each fixing piece 32, a plurality of second locking portions 33 are provided along a direction perpendicular to the placement surface 24. The number of second locking portions 33 is the same for each fixing piece 32. In addition, the interval between the second locking portions 33 in the direction perpendicular to the placement surface 24 is also the same for each fixing piece 32. Although three second locking portions 33 are illustrated in each fixing piece 32 in the drawings, the number of second locking portions 33 in each fixing piece 32 is not limited to three, and may be two or four or more.

Each first locking portion 25 is configured to engage with any one of the second locking portions 33 of the corresponding fixing piece 32. The distance between the body portion 31 of the clamping member 30 and the placement surface 24 of the attachment portion 22 is changed depending on the second locking portions 33 of the fixing piece 32 that engage with the first locking portions 25

The clamping member 30 has, for example, a covering portion 34. The covering portion 34 is formed, for example, between the fixing pieces 32 in the height direction D2 in the clamping member 30. The covering portion 34 extends from the opposite end portions of the body portion 31 in the width direction D1. The covering portion 34 faces the side surface 22a of the attachment portion 22 in the width direction D1. The covering portion 34 is configured to cover a gap between the placement surface 24 and the body portion 31 in the width direction D1. As a result, the covering portion 34 prevents the fixed portion 13 from being exposed from the gap between the placement surface 24 and the body portion 31 when viewed in the width direction D1.

### Operations of Embodiment

The following describes how the wire fixing member 12 is attached to the fixed portion 13.

First, the fixed portion 13 is disposed on the placement surface 24 of the fixing member body 20. At this time, the protruding portion 26 of the placement surface 24 is inserted into the hole 14 of the fixed portion 13.

Next, the clamping member 30 is attached to the attachment portion 22 by the second locking portions 33 of the clamping member 30 engaging with the corresponding first locking portions 25 of the attachment portion 22 of the fixing member body 20. As a result, the fixed portion 13 is clamped between the placement surface 24 of the attachment portion 22 and the body portion 31 of the clamping member 30 in the thickness direction. At this time, the distance between the placement surface 24 of the attachment portion 22 and the body portion 31 of the clamping member 30 can be adjusted depending on the second locking portions 33 of the fixing piece 32 that engage with the first locking portions 25. Therefore, by adjusting the distance between the placement surface 24 and the body portion 31 of the clamping member 30 in accordance with the thickness of the fixed portion 13, it is possible to clamp the fixed portion 13 between the placement surface 24 and the body portion 31 of the clamping member 30 while suppressing rattling.

### (1) Effects of Embodiment

The wire fixing member 12 includes the fixing member body 20 and the clamping member 30 to be attached to fixing member body 20. The placement surface 24 of the fixing member body 20 and the clamping member 30 are configured to clamp the fixed portion 13 therebetween. According to this configuration, by changing the distance between the placement surface 24 of the fixing member body 20 and the clamping member 30, it is possible to clamp various types of fixed portions 13 having different thicknesses while suppressing rattling. By changing the distance between the placement surface 24 and the clamping member 30 in accordance with the thickness of the fixed portion 13, it is possible to accommodate various types of fixed portions 13 having different thicknesses. Accordingly, the versatility of the wire fixing member 12 can be improved.

(2) The fixing member body 20 has the first locking portions 25. The clamping member 30 has, for example, the second locking portions 33 that engage with the first locking portions 25. The fixing member body 20 and the clamping member 30 are fixed to each other by the first locking portions 25 and the second locking portions 33 engaging with each other. The first locking portions 25 and the second locking portions 33 are configured to fix the clamping member 30 at a plurality of fixing positions having different distances from the placement surface 24. According to this configuration, the distance between the placement surface 24 of the fixing member body 20 and the clamping member 30 can be changed by the configuration of the first locking portions 25 and the second locking portions 33.

(3) A plurality of combinations of the first locking portion 25 and the second locking portion 33 that engages with the first locking portion 25 are provided. According to this configuration, by providing the plurality of combinations of the first locking portion 25 and the second locking portion 33, it is possible to firmly fix the clamping member 30 to the fixing member body 20.

(4) The placement surface 24 has the protruding portion 26 that are inserted into the hole 14 provided in the fixed portion 13. According to this configuration, the protruding portion 26 inserted into the hole 14 of the fixed portion 13 can prevent the fixed portion 13 from coming out of the space between the placement surface 24 and the clamping member 30.

### Variations

The present embodiment can be implemented with variations such as the following. The present embodiment and the following variations can be implemented in combination with each other as long as no technical contradiction arises.
The configuration of the first locking portions 25 of the fixing member body 20 and the second locking portions 33 of the clamping member 30 is not limited to the above embodiment. The first locking portions 25 and the second locking portions 33 only need to be configured to fix the clamping member 30 at a plurality of fixing positions having different distances from the placement surface 24. For example, the configuration of the first locking portions 25 and the second locking portions 33 can be modified as shown in FIG. 4.

As shown in FIG. 4, the attachment portion 22 of the fixing member body 20 has a first locking portion 51 having a shape with a plurality of recesses and protrusions. The first locking portion 51 is provided, for example, on at least a portion of an inner surface of a tubular portion 52 formed on a side surface 22a of the attachment portion 22 in the width direction D1. In the first locking portion 51, the plurality of recesses and protrusions are alternatingly arranged along the direction perpendicular to the placement surface 24.

The fixing piece 32 of the clamping member 30 has a second locking portion 53 having a shape with a plurality of recesses and protrusions. In the second locking portion 53, a plurality of recesses and protrusions are alternatingly arranged along a direction perpendicular to the placement surface 24. The shape with the recesses and protrusions of the second locking portion 53 is formed similarly to the shape with the recesses and protrusions of the first locking portion 51. When the fixing piece 32 is inserted into the tubular portion 52, the first locking portion 51 and the second locking portion 53 are engaged with each other in the direction perpendicular to the placement surface 24.

The first locking portion 51 and the second locking portion 53 have a configuration in which a plurality of recesses and protrusions are alternatingly arranged along a direction perpendicular to the placement surface 24. As a result, the first locking portion 51 and the second locking portion 53 can fix the clamping member 30 at a plurality of fixing positions having different distances from the placement surface 24. With such a configuration as well, the distance between the placement surface 24 and the clamping member 30 can be changed by the configuration of the first locking portion 51 and the second locking portion 53.
In the above embodiment, the protruding portion 26 to be inserted into the hole 14 of the fixed portion 13 is provided on the placement surface 24, but there is not limitation thereto, and the protruding portion to be inserted into the hole 14 of the fixed portion 13 may be provided on the body portion 31 of the clamping member 30.
The locking hole 14 in the fixed portion 13 may be a recessed portion formed in the first main surface 13x. In other words, the hole 14 of the fixed portion 13 may be configured not to extend through from the first main surface 13x to the second main surface 13y of the fixed portion 13.
In the wire fixing member 12 of the above embodiment, the clamping member 30 is fixed to the fixing member body 20 by engagement of the first locking portions 25 of the fixing member body 20 with the second locking portions 33 of the clamping member 30, but there is no particular limitation thereto. For example, the wire fixing member 12 may include a coupling member separate from each of the fixing member body 20 and the clamping member 30, and the attachment portion 22 of the fixing member body 20 and the clamping member 30 may be coupled to each other by the coupling member. In this case, the coupling member couples the attachment portion 22 to the clamping member 30 such that the distance between the body portion 31 of the clamping member 30 and the placement surface 24 can be changed. Accordingly, the distance between the body portion 31 of the clamping member 30 and the placement surface 24 can be adjusted in accordance with the thickness of the fixed portion 13.
The configuration such as the shape of the holding portion 21 in the wire fixing member 12 is not limited to the above embodiment. For example, the holding portion 21 may be an extending piece extending in the length direction of the wire member 11, and the wire member 11 may be fixed to the extending piece by winding tape or other means.
In the fixing member body 20, the attachment portion 22 may be formed only in either the first part 41 or the second part 42.
The fixed portion 13 in the above embodiment has a flat plate shape, but there is no limitation to this. For example, the end portion of the fixed portion 13 in the width direction D1 may be bent at a substantially right angle, for example.
In the non-limiting embodiment shown in FIGS. 1 to 3, the placement surface 24 of the attachment portion 22 may be configured to be in direct contact the first main surface 13x of the plate-like fixed portion 13, and may be referred to as a first receiving surface or a first flat receiving surface. The clamping member 30 may be configured to be in direct contact with the first main surface 13x of the plate-like fixed portion 13, and may include a second receiving surface or a second flat receiving surface configured to clamp the plate-like fixed portion 13 in cooperation with the placement surface 24 (first receiving surface) of the attachment portion 22.

When the clamping member 30 is attached to the attachment portion 22, the first receiving surface (the placement surface 24) of the attachment portion 22 and the second receiving surface of the clamping member 30 may define a slot capable of receiving the plate-like fixed portion 13 therebetween. A separation distance between the first receiving surface (placement surface 24) of the attachment portion 22 and the second receiving surface of the clamping member 30 may be referred to as a slot width. The plurality of second locking portions 33 may be configured such that, when the clamping member 30 is attached to the attachment portion 22, the first receiving surface (the placement surface 24) of the attachment portion 22 and the second receiving surface of the clamping member 30 are separated from each other by one separation distance selected from a plurality of predetermined separation distances.
The plurality of second locking portions 33 of the clamping member 30 may be set in association with the thicknesses of a plurality of plate-like fixed portions 13 having different thicknesses. By the first locking portion 25 of the attachment portion 22 engaging with one of the plurality of second locking portions 33 of the clamping member 30 corresponding to the thickness of the selected plate-like fixed portion 13, the plate-like fixed portion 13 may be fixedly clamped by the attachment portion 22 and the clamping member 30, and the clamping member 30 may be fixedly attached to the attachment portion 22.
Note that the embodiments and variations disclosed herein are to be considered as illustrative and non-limiting in all aspects. The scope of the present disclosure is indicated by the claims rather than the meaning described above, and is intended to include all changes within the meaning and scope equivalent to the claims.

1. A wire fixing member that is configured to fix a wire to a fixed portion, the wire fixing member comprising:
a fixing member body configured to hold the wire and having a placement surface on which the fixed portion is to be disposed; and
a clamp that is separate from the fixing member body and is to be attached to the fixing member body,
wherein the placement surface and the clamp are configured to clamp the fixed portion therebetween.

2. The wire fixing member according to claim 1, wherein:
the fixing member body includes a first lock,
the clamp includes a second lock configured to engage with the first lock,
the fixing member body and the clamp are fixed to each other by engagement of the first lock and the second lock, and
the first lock and the second lock are configured to fix the clamp at a plurality of fixing positions having different distances from the placement surface.

3. The wire fixing member according to claim 2,
wherein a plurality of combinations of the first lock and the second lock engaging with the first lock are provided.

4. The wire fixing member according to claim 1,
wherein one of the placement surface and the clamp includes a protrusion that is to be inserted into a hole provided in the fixed portion.

5. A wire harness comprising:
the wire fixing member according to claim 1, and
the wire held by the wire fixing member.
